(19) United States
(12) Patent Application Publication
(10) Pub. No.: US 2002/0083311 A1
(43) Pub. Date: Jun. 27, 2002

(54) Method and computer program for single instruction multiple data management

(76) Inventor: Nigel C. Paver, Austin, TX (US)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/748,165

(22) Filed: Dec. 27, 2000

(51) Int. Cl. G06F 9/00

(52) U.S. Cl. 712/236

(57) ABSTRACT

A method and computer program for extracting and combining arithmetic flags utilized in the processing multiple data items in a single instruction multiple data (SIMD) capable processor. In a SIMD processor several pieces of data may be manipulated by the same instruction at any given moment. However, the results for the execution of this instruction vary according to the data being manipulated. The method and computer program allows a simple mechanism in which these arithmetic flags maybe extracted and combined so as to maximize processor efficiency while saving space, reducing power requirements and heat generated by the processor.

### FIELD

The invention relates to a method and computer program for single instruction multiple data (SIMD) management. More particularly, the present invention manages the arithmetic flags associated with individual data items so that a processor with SIMD capability may logically combine these arithmetic flags so that simultaneous processing of multiple data items may be done at the same time in a simple and efficient manner.

### BACKGROUND

In the rapid development of computers many advancements have been seen in the areas of processor speed, throughput, communications, and fault tolerance. Initially computer systems were standalone devices in which a processor, memory and peripheral devices all communicated through a single bus. Later, in order to improve performance, several processors were interconnected to memory and peripherals using one or more buses. In addition, separate computer systems were linked together through different communications mechanisms such as, shared memory, serial and parallel ports, local area networks (LAN) and wide area networks (WAN). Further, in order to improve processor instruction processing, pipelining was developed to enable a processor to execute an instruction in stages and a single processor could execute different instructions at different stages of execution simultaneously.

A further development created in order to enhance processor performance is the use of a technique known as single instruction multiple data (SIMD). SIMD is a technique where several different pieces of data may be simultaneously accessed and arithmetically manipulated by a processor. This ability to manipulate several pieces of data at the same time greatly enhances the performance of the processor. However, even though the same arithmetic operation may be performed, the results and status for each piece of data may be different. For example, the data may be negative, zero, have a carry out or overflow condition resulting. Since a SIMD processor may manipulate as many as eight pieces, or more, of data simultaneously, the processor is required to maintain at least eight sets of these condition flags. Further, in order to receive the benefit of SIMD processing it is necessary to logically combine these condition or arithmetic flags so that the appropriate operation may occur under the appropriate conditions. Since it may be necessary to manipulate eight pieces, or more, of data under many different combinations of possible outcomes, the logic that must be built into a processor and microprocessor design can be very cumbersome. Valuable space on the microprocessor must be dedicated to this processing and the speed, size, power required, and heat generated by the processor may be seriously effected.

Therefore, what is needed is a method and computer program which will combine the arithmetic or condition flags in a simple manner so that the appropriate operation will be performed under the appropriate conditions. Further, this method and computer program should allow for the testing of all arithmetic functions and condition flags at once in a simple manner. In addition, this method and computer program should be able to simply extract individual arithmetic flags for individual data items when necessary.

### BRIEF DESCRIPTION OF THE DRAWINGS

The foregoing and a better understanding of the present invention will become apparent from the following detailed description of exemplary embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto. The spirit and scope of the present invention are limited only by the terms of the appended claims.

The following represents brief descriptions of the drawings, wherein:

FIG. 1A is an example embodiment of the arithmetic flags in an SIMD word for eight data items stored in a processor status register (PSR) used in an example embodiment of the present invention;

FIG. 1B is an example embodiment of the arithmetic flags in an SIMD word for four data items stored in a PSR used in example embodiment of the present invention;

FIG. 1C is an example embodiment of the arithmetic flags in an SIMD word for two data items stored in a PSR used in an example embodiment of the present invention;

FIG. 1D is an example embodiment of the arithmetic flags in an SIMD word for one data item stored in a PSR used in an example embodiment of the present invention;

FIG. 2 is a systems diagram of an example embodiment of the present invention;

FIG. 3 is an example flowchart of a general embodiment of the present invention;

FIG. 4 is a flowchart of an AND function used in an example embodiment of the present invention;

FIG. 5 is a flowchart of an OR function used in an example embodiment of the present invention; and

FIG. 6 is a flowchart of an EXTRACT function used in an example embodiment of the present invention.

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, exemplary sizes/models/values/ranges may be given, although the present invention is not limited to the same. As a final note, well-known components of computer networks may not be shown within the FIGS. for simplicity of illustration and discussion, and so as not to obscure the invention.

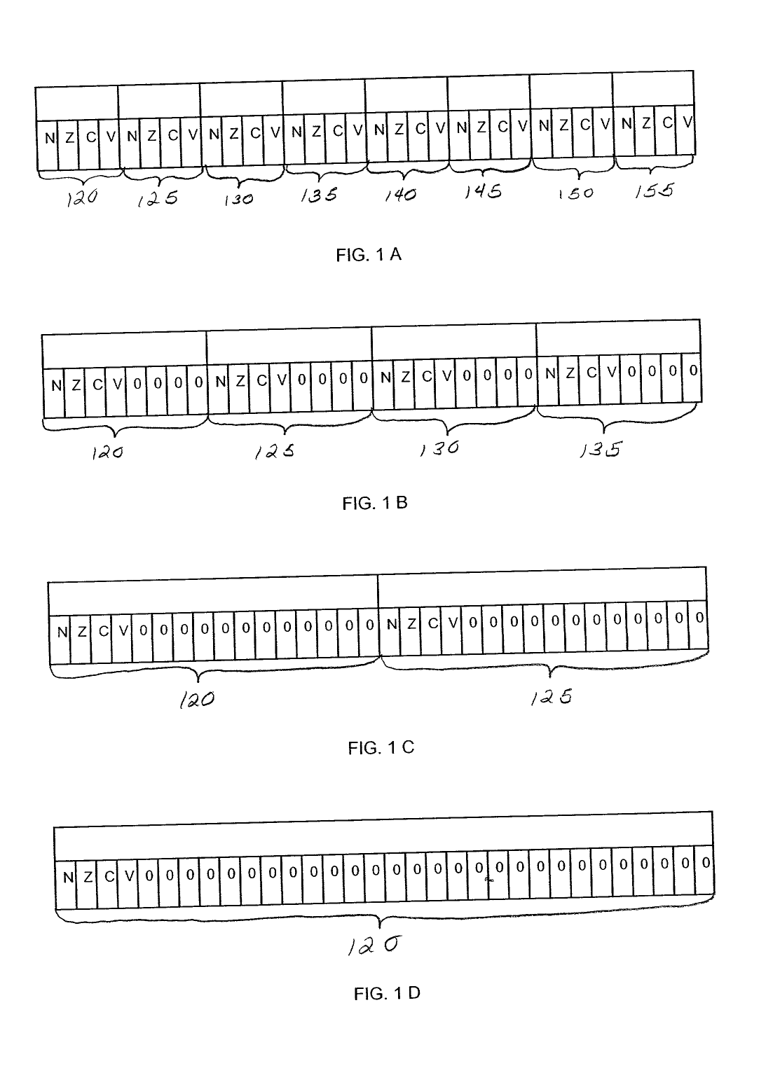

FIG. 1A through 1D are representative examples of SIMD words utilized to indicate the arithmetic flags associated with data items being manipulated by a processor having SIMD capability in the example embodiments of the present invention. FIG. 1A represents an SIMD word having eight sets of SIMD flags contained therein labeled 120, 125, 130, 135, 140, 145,150 and 155. Each SIMD set (120,125, 130, 135,140,145, 150 and 155) has four variables associated with it designated N, Z, C, and V. N represents a data item which has a negative value. Z represents a data item which has a value of zero. C represents a carry out condition in a data item which would occur in the case of an overflow for a byte or word having a sign bit. V represents an overflow condition having occurred for an associated data item. It should be noted that N, Z, C, and V are only examples of arithmetic flags. As would be appreciated by one of ordinary skill in the art many more such flags or conditions may be created for results generated by arithmetic functions. Therefore, the flags indicated in FIGS. 1A through 1D are provided as examples only and it is not intended that the present invention be limited the use of these flags or conditions only.

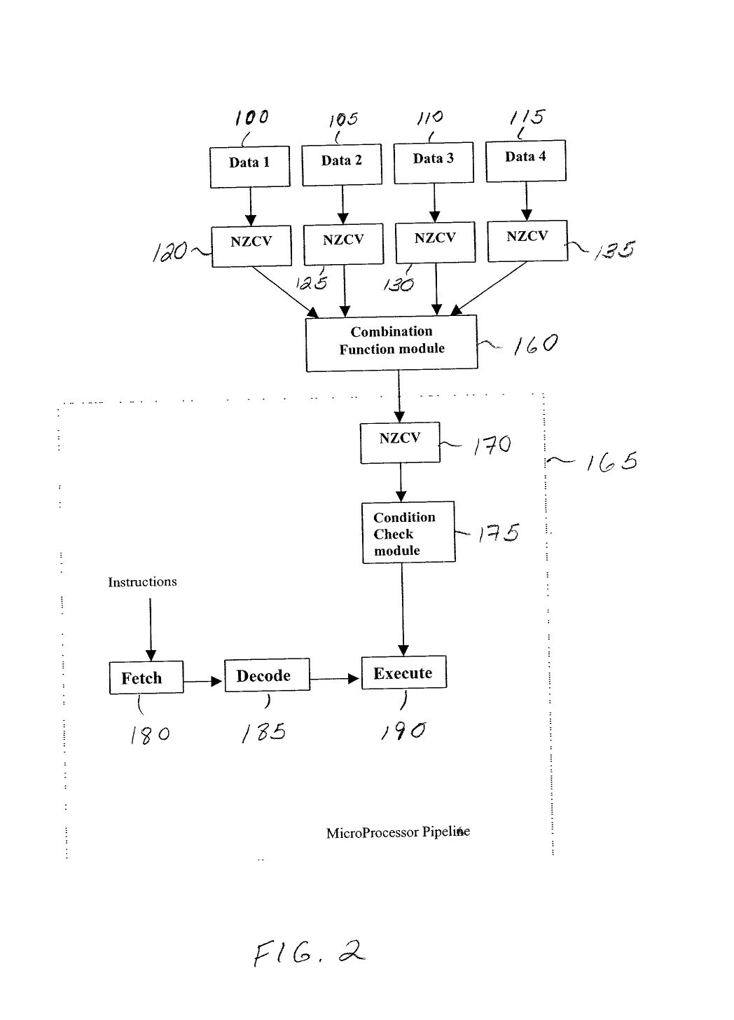

Referring to FIG. 1A, eight sets of arithmetic flags (120,125,130,135,140, 145, 150 and 155) are shown in which each set of flags is associated with an individual data item. Therefore, the first set of flags composed of N, Z, C, and V is associated with the first data item 120 while the second 125, third 130, and fourth 135 through eighth 155 are associated with the first, second, third, and fourth through eighth data items further illustrated in FIG.2 and discussed ahead. It should be noted that this particular SIMD word contains 32 bits. However, the present invention is not restricted to the use of a 32-bit SIMD word. It is possible for a 64-bit SIMD word to be utilized in which the embodiments of the present invention may utilize this 64-bit SIMD word to operate.

Referring to FIG. 1B, it should be noted that the SIMD word illustrated is similar to that shown in FIG. 1A, however, only four sets of arithmetic flags (120, 125, 130 and 135) are set. As with FIG. 1A, the same N, Z, C, and V designation is used with the exception that each byte has the least significant bits occupied by the value zero.

Referring to FIG. 1C, this figure is similar to FIG. 1A and FIG. 1B with the exception that only two sets of arithmetic flags (120 and 125) are represented. Therefore, each of the least significant bits not used in each half word are filled with value zero.

Referring to FIG. 1D, this figure is similar to FIG. 1A, 1B, and 1C with the exception that only one set of arithmetic flags (120) are represented. Therefore, each of the least significant bits not used in each word are filled with value zero.

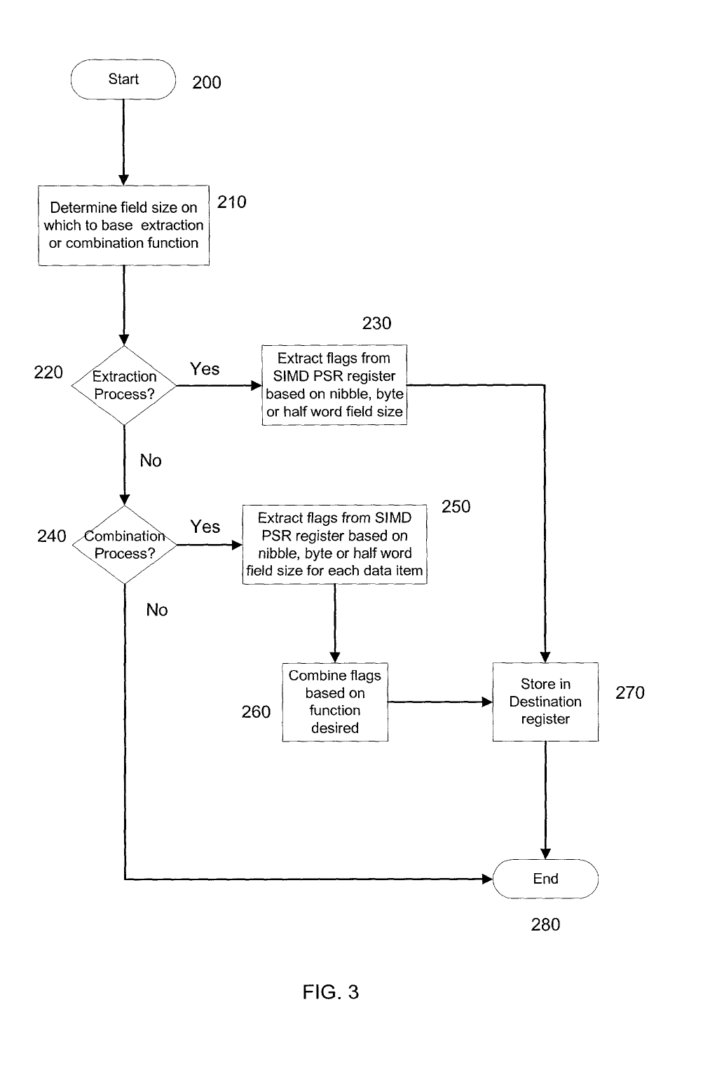

FIG. 2 is a systems diagram of an example embodiment of the present invention. As illustrated in FIG. 1B, arithmetic flags 120, 125, 130 and 135 are shown in FIG. 2. However, in addition arithmetic flags 120, 125, 130 and 135 are each associated with data items 100, 105, 110 and 115 respectively. As previously discussed, in order for a SIMD capable processor, such as processor 165, to effectively be able to manipulate multiple pieces of data (100-115) it is necessary to logically combine the results of mathematical operations shown in arithmetic flags 100, 125,130 and 135. This is accomplished by the combination function module 160 utilizing the methods and operations illustrated and further discussed in reference to FIGS. 3-6. The results of the combination function performed by the combination function module 160 is a combined arithmetic flag variable 170. Thereafter, a condition check module 175 is utilized to determine the next operation to perform based upon the combined arithmetic flag variable 170. These operations will be discussed further detail ahead.

Still referring to FIG. 2, as discussed earlier, pipelining is a common form of computer architecture. In processor 165 at least three stages of pipelining are shown. The first stage of pipelining is the fetch 180 operation in which instructions are retrieved from memory (not shown) for execution. The second stage of pipelining is a decode operation 185 in which the instruction is decoded by the processor. Finally, the last stage of this example processor pipeline is the execute 190 stage in which the instruction is executed based upon input from the condition check module 175. As would be appreciated by one of ordinary skill in the art, the example processor pipeline shown in FIG. 2 is merely an example. Many more stages of pipelining are possible.

Before proceeding into a detailed discussion of the logic used by the present invention it should be mentioned that the flowcharts shown in FIGS. 3 through 6 or contain software, firmware, hardware, processes or operations that correspond, for example, to code, sections of code, instructions, commands, objects, hardware or the like, of a computer program that is embodied, for example, on a storage medium such as floppy disk, CD-Rom (Compact Disc read-only Memory), EP-Rom (Erasable Programmable read-only Memory), RAM (Random Access Memory), hard disk, etc. Further, the computer program can be written in any language such as, but not limited to, for example C++. Further, the logic shown in FIGS. 3-6 are executed by the modules and processor 165 shown in FIG. 2.

FIG. 3 is an of an example flowchart of a general embodiment of the present invention. Logic utilized in the flowchart illustrated in FIG. 3 maybe used to combine, group, or extract the arithmetic flags illustrated in FIGS. 1A through 1B. The functions that may be executed by the condition check module 175 would include, but not be limited to, the following functions.

1. If any field has overflowed;

2. If any field has not overflowed;

3. If any field is positive (or zero);

4. If any field is negative;

5. If any field is zero;

6. If any field is not zero;

7. If any field has a carry out;

8. If any field does not have a carry out;

9. If all fields have overflowed;

10. If all fields have not overflowed;

11. If any field are positive (or zero);

12. If all fields are negative;

13. If all fields are zero;

14. If all fields are not zero;

15. If all fields have a carry out; and

16. If all fields do not have a carry out.

As would be appreciated by one order skill of the art the foregoing functions may be increased to include any mathematical functions including less than, greater than, less than or equal to, and greater than or equal to. Additional, mathematical operators and functions may be used in conjunction with the present invention.

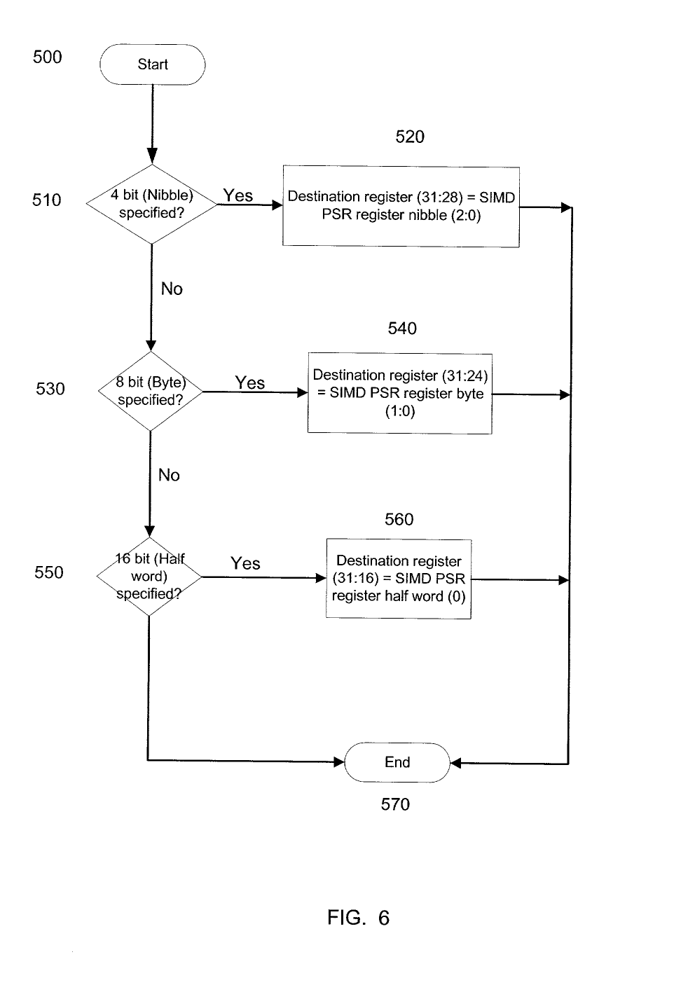

Still referring to FIG. 3, processing begins in operation 200 and immediately proceeds operation 210. In operation 210, a field size is determined on which to base the extraction or combination function. The field size may be, but not limited to, a nibble, byte, half word, word, or double word in size. The extraction and/or combination function may include any of the foregoing 16 items discussed or any other function which may describe or combine the status or result of a mathematical operation performed by a computer or processor. Thereafter, processing proceeds operation 220 where it is determined if an extraction process is being performed. If an extraction process is being performed processing then proceeds operation 230. In operation 230, the flags, illustrated in FIGS. 1A through 1D, are extracted based upon the field size determined in operation 210 and the specific data item desired. Thereafter, processing proceeds operation 270 where the extracted information is stored in the destination register. Once stored processing proceeds to operation 280 where processing terminates. In an example embodiment shown in FIG. 6, the extraction process is further detailed as discussed ahead.

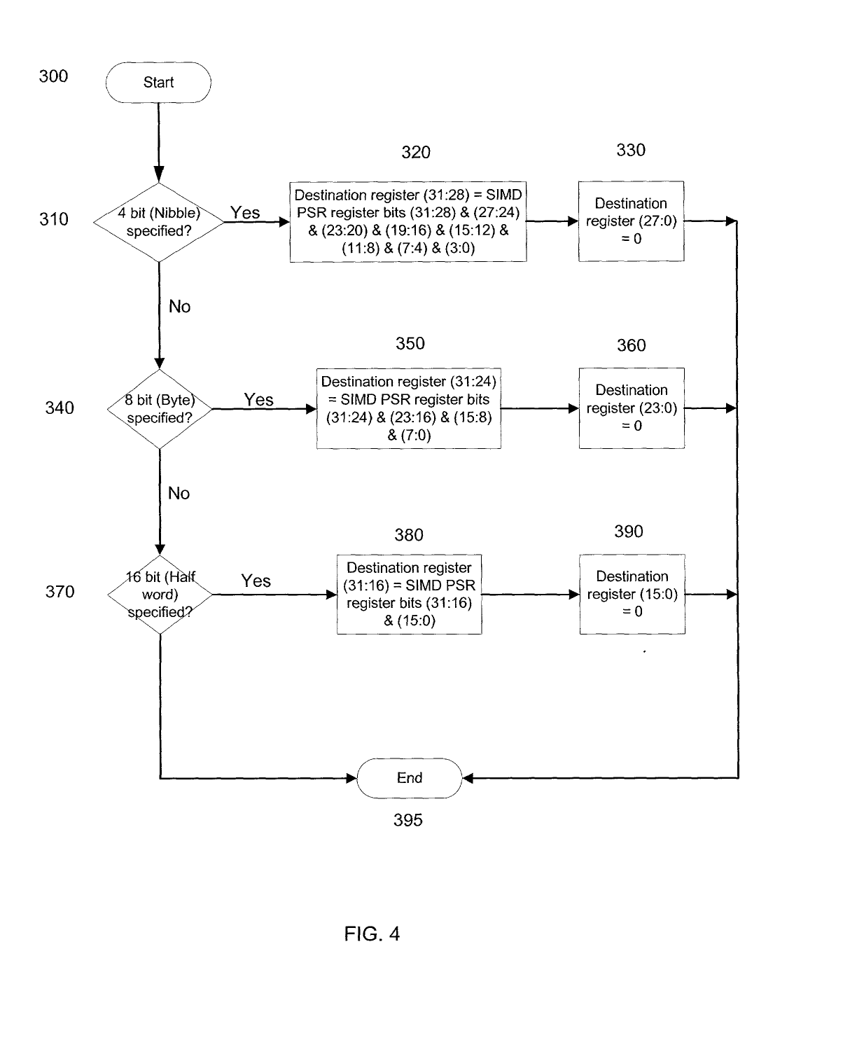

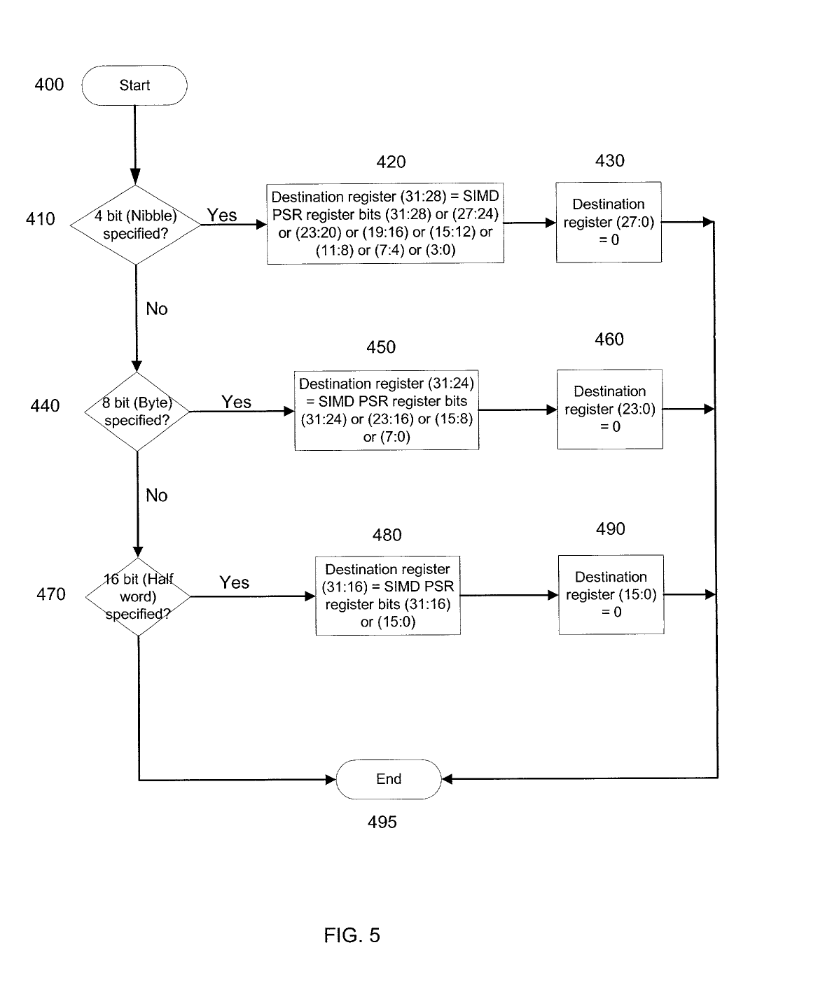

If in operation 220 it is determined that an extraction process is not desired, then processing proceeds operation 240. In operation 240 it is determined whether a combination process executed by the condition check module 175 for the arithmetic flags illustrated in FIGS. 1A through 1D is desired. If a combination process is not desired then processing proceeds operation 280 where again processing terminates. However, if a combination process executed by the condition check module 175 is desired for the flags associated with several data items shown in FIGS. 1A through 1D, then processing proceeds operation 250. In operation 250, the flags for each data item in the SIMD PSR register are extracted based on the field size determined in operation 210. Processing then proceeds to operation 260 where the extracted flags for each data item are combined based upon the function desired. Specific examples of combination functions for an AND operation and an OR operation are further detailed in the discussion of FIG. 4 and FIG. 5, respectively. Thereafter, processing proceeds to operation 270 where the results of the combined flags are stored in the destination register for access by the processor. Processing then terminates in operation 280.

FIG. 4 is an of a flowchart of an AND function used in an example embodiment of the present invention and may be executed by the condition check module 175. Processing for this AND operation begins in operation 300 and immediately proceeds operation 310. In operation 310 it is determined whether the data field size is four bits (one nibble) in length. If the data field size is four bits in length then processing proceeds to operation 320. In operation 320, bits 31 through 28 of the destination register are set equal to bits 31 through 28 anded with bits 27 through 24 anded with bits 23 through 20 anded with bits 19 through 16 anded with bits 15 through 12 anded with bits 11 through 8 anded with the 7 through 4 and 3 through 0 of the SIMD PSR register. Thereafter, processing proceeds to operation 320 where the remaining bits 27 through 0 of the destination register are set to zero. Processing then proceeds to operation 395 where processing terminates.

Still referring to FIG. 4, if in operation 310 it is determined that a four bits data field is not specified then processing proceeds to operation 340. In operation 340, it is determined whether an 8 bit (byte) data field is specified. If an 8 bit data field is specified in the SIMD data word, shown in FIG. 1B, then processing proceeds to operation 350. In operation 350, bits 31 through 24 of the destination register are set equal to bits 31 through 24 anded with bits 23 through 16 anded with bits 15 through 8 and bits 7 through 0 of the SIMD PSR register. Thereafter, processing proceeds to operation 360 where bits 23 through 0 of the destination register are set to zero. Processing then terminates in operation 395.

Still referring to FIG. 4, if in operation 340 it is determined that an 8 bit data field is not specified, then processing proceeds operation 370. In operation 370 it is determined whether a 16-bit (half word) data field is specified. If a 16-bit data field is specified, as shown in FIG. 1C, then processing proceeds to operation 380. In operation 380, bits 31 through 16 of the destination register are set equal to bits 31 through 16 anded with bits 15 through 0 of the SIMD PSR register. Thereafter, processing proceeds to operation 390 where bits 15 through 0 of the destination register are set to zero. Then, in operation 395, processing is terminated.

FIG. 5 is an of a flowchart of an OR function used in an example embodiment of the present invention and may be executed by the condition check module 175. Processing for this OR operation begins in operation 400 and immediately proceeds operation 410. In operation 410 it is determined whether the data field size is four bits (one nibble) in length. If the data field size is four bits in length then processing proceeds to operation 420. In operation 420, bits 31 through 28 of the destination register are set equal to bits 31 through 28 ORD with bits 27 through 24 ORD with bits 23 through 20 ORD with bits 19 through 16 ORD with bits 15 through 12 ORD with bits 11 through 8 ORD with the 7 through 4 ORD with 3 through 0 of the SIMD PSR register. Thereafter, processing proceeds to operation 420 where the remaining bits 27 through 0 of the destination register are set to zero. Processing then proceeds to operation 495 where processing terminates.

Still referring to FIG. 5, if in operation 410 it is determined that a four bits data field is not specified, then processing proceeds to operation 440. In operation 440, it is determined whether an 8 bit (byte) data field is specified. If an 8 bit data field is specified in the SIMD data word shown in FIG. 1B, then processing proceeds to operation 450. In operation 450, bits 31 through 24 of the destination register are set equal to bits 31 through 24 ORD with bits 23 through 16 ORD with bits 15 through 8 ORD with bits 7 through 0 of the SIMD PSR register. Thereafter, processing proceeds to operation 460 where bits 23 through 0 of the destination register are set to zero. Processing then terminates in operation 495.

Still referring to FIG. 5, if in operation 440 it is determined that an 8 bit data field is not specified, then processing proceeds operation 470. In operation 470 it is determined whether a 16-bit (half word) data field is specified. If a 16-bit data field is specified, as shown in FIG. 1C, then processing proceeds to operation 480. In operation 480, bits 31 through 16 of the destination register are set equal to bits 31 through 16 ORD with bits 15 through 0 of the SIMD PSR register. Thereafter, processing proceeds to operation 490 where bits 15 through 0 of the destination register are set to zero. Then in operation 495 processing is terminated.

FIG. 6 is a flowchart of an EXTRACT function used in an example embodiment of the present invention and may be executed by the condition check module 175. The extract function begins execution in operation 500 and immediately proceeds to operation 510. In operation 510, it is determined whether the data field illustrated in FIG. 1A for the SIMD word is four bits (one nibble) in length. If the data field is determined to be four bits in length, in operation 510, then processing proceeds operation 520. In operation 520, bits 31 through 28 of the destination register are set equal to nibble 2 through 0 of the SIMD PSR register. Thereafter, processing proceeds to operation 570 where processing terminates.

However, if in operation 510 it is determined the data field is not equal to four bits in length then processing proceeds to operation 530. In operation 530, it is determined whether the data field is eight bits (one byte) in length. If the data field in the SIMD word is eight bits in length, as shown in FIG. 1B, then processing proceeds to operation 540. In operation 540, bits 31 through 24 of the destination register are set equal to bytes 1 through 0 of the SIMD PSR register. Again, processing then proceeds to operation 570 where processing terminates.

Still referring to FIG. 6, if in operation 530 it is determined that the data field in the at SIMD word is not one byte in length, then processing proceeds to operation 550. In operation 550, it is determined whether the data field length in the SIMD word is 16 bits (half word) in length. If the data field in the SIMD word is 16 bits in length, then processing proceeds to operation 560. In operation 560, bits 31 through 16 of the destination register are set equal to half word 0 in the SIMD PSR register. Thereafter, processing proceeds to operation 570 where processing terminates. Further, if it is determined in operation 550 that the data field length of the at SIMD word is not 16 bits, then processing proceeds to operation 570 where processing terminates.

The benefit resulting from the present invention is that a simple, reliable, fast method and computer program is provided that will enable a SIMD capable processor of extracting and/or combining arithmetic flags associated with multiple data items that have been the subject of mathematical operations. This method and computer program is of such in nature that complex logic is not required thus saving space, power requirements and heat generated by a processor. Further, this method and computer program allows a SIMD capable processor of operating at peak efficiency due to the simplicity of the logic required.

While we have shown and described only a few examples herein, it is understood that numerous changes and modifications as known to those skilled in the art could be made to the example embodiment of the present invention. Therefore, we do not wish to be limited to the details shown and described herein, but intend to cover all such changes and modifications as are encompassed by the scope of the appended claims.

I claim:

1. A device for combining a plurality of arithmetic flags, comprising:
a combination function module that examines a plurality of arithmetic flags, determines field size of the plurality of arithmetic flags and based on the determination of the field size will combine the plurality of arithmetic flags into a single combined arithmetic flag variable, wherein the plurality of arithmetic flags represent the status of a plurality of data items after a mathematical operation is performed by the processor on the plurality of data items.

2. The device recited in claim 1, further comprising:
a condition check module that determines the status of the combined arithmetic flag variable and causes the processor to execute an appropriate operation based on the status.

3. The device recited in claim 1, wherein the field size is based either a nibble, byte, half word, or word in length.

4. The device recited in claim 3, wherein the plurality of arithmetic flags further comprise:
a negative data value, a zero data value, a carry out occurrence in a data value, or an overflow condition in a data item in the plurality of data items.

5. The device recited in claim 4, the combination function module performs either an AND or an OR operation.

6. The device recited in claim 2, wherein the status determined by the condition further comprises:
any data item has overflowed;
any data item has not overflowed;
any data item is positive or zero;
any data item is negative;
any data item is zero;
any data item is not zero;
any data item has a carry out;
any data item does not have a carry out;
all data items have overflowed ;
all data items have not overflowed;
all data items are positive or zero;
all data items are negative;
all data items are zero;
all data items are not zero;
all data items have a carry out; and
all data items do not have a carry out.

7. A method of combining a plurality of arithmetic flags for presentation to a processor, comprising:
determining a field size of the plurality of arithmetic flags on which to base a combination process, wherein the plurality of arithmetic flags represent the status of a plurality of data items after a mathematical operation is performed by the processor on the plurality of data items;
extracting the plurality of arithmetic flags based on the field size;
combining the plurality of arithmetic flags based on a function selected when a combination process is selected; and
storing a result of the combining of the plurality of arithmetic flags in a destination register for access by the processor.

8. The method recited in claim 7, wherein the field size is based either a nibble, byte, half word, or word in length.

9. The method recited in claim 8, wherein the plurality of arithmetic flags further comprise:
a negative data value, a zero data value, a carry out occurrence in a data value, or an overflow condition in a data item in the plurality of data items.

10. The method recited in claim 9, wherein the function further comprises: an AND or OR operation.

11. The method recited in claim 10, wherein the function may be used to determine the status of the plurality of data items, said status comprising:
any data item has overflowed;
any data item has not overflowed;
any data item is positive or zero;
any data item is negative;
any data item is zero;
any data item is not zero;
any data item has a carry out;
any data item does not have a carry out;
all data items have overflowed;
all data items have not overflowed;
all data items are positive or zero;
all data items are negative;
all data items are zero;
all data items are not zero;
all data items have a carry out; and
all data items do not have a carry out.

12. An apparatus comprising a data storage medium for storing instructions when executed by a processor results in, comprising:
determining a field size of the plurality of arithmetic flags on which to base a combination process, wherein the plurality of arithmetic flags represent the status of a plurality of data items after a mathematical operation is performed by the processor on the plurality of data items;
extracting the plurality of arithmetic flags based on the field size;
combining the plurality of arithmetic flags based on a function selected when a combination process is selected; and
storing a result of the combining of the plurality of arithmetic flags in a destination register for access by the processor.

13. The apparatus recited in claim 12, wherein the field size is based either a nibble, byte, half word, or word in length.

14. The apparatus recited in claim 13, wherein the plurality of arithmetic flags further comprise:
a negative data value, a zero data value, a carry out occurrence in a data value, or an overflow condition in a data item in the plurality of data items.

15. The apparatus recited in claim 14, wherein the function further comprises an AND or OR operation.

16. The apparatus recited in claim 15, wherein the function may be used to determine the status of the plurality of data items, said status comprising:
any data item has overflowed;
any data item has not overflowed;
any data item is positive or zero;
any data item is negative;
any data item is zero;
any data item is not zero;
any data item has a carry out;
any data item does not have a carry out;
all data items have overflowed;
all data items have not overflowed;
all data items are positive or zero;
all data items are negative;
all data items are zero;
all data items are not zero;
all data items have a carry out; and
all data items do not have a carry out.

17. A method of extracting a plurality of arithmetic flags for presentation to a processor, comprising:
determining a field size of the plurality of arithmetic flags on which to base a combination process, wherein the plurality of arithmetic flags represent the status of a plurality of data items after a mathematical operation is performed by the processor on the plurality of data items;
extracting the plurality of arithmetic flags based on the field size; and
storing a result of the extracting of the plurality of arithmetic flags in a destination register for access by the processor.

18. The method recited in claim 17, wherein the field size is based either a nibble, byte, or half word in length.

19. The method recited in claim 18, wherein the plurality of arithmetic flags further comprise:
a negative data value, a zero data value, a carry out occurrence in a data value, or an overflow condition in a data item in the plurality of data items.

20. A method of extracting a plurality of arithmetic flags for presentation to a processor, comprising:
determining a field size of the plurality of arithmetic flags on which to base a combination process, wherein the plurality of arithmetic flags represent the status of a plurality of data items after a mathematical operation is performed by the processor on the plurality of data items;
extracting the plurality of arithmetic flags based on the field size; and
storing a result of the extracting of the plurality of arithmetic flags in a destination register for access by the processor.

21. The method recited in claim 20, wherein the field size is based either a nibble, byte, or half word in length.

22. The method recited in claim 21, wherein the plurality of arithmetic flags further comprise:
a negative data value, a zero data value, a carry out occurrence in a data value, or an overflow condition in a data item in the plurality of data items.
